(19) United States
(12) Patent Application Publication
(10) Pub. No.: US 2004/0254507 A1
(43) Pub. Date: Dec. 16, 2004

(54) Hand-held massage device with removable handle

(76) Inventor: Robert Off, Escondido, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/868,992

(22) Filed: Jun. 15, 2004

Related U.S. Application Data
(60) Provisional application No. 60/478,717, filed on Jun. 16, 2003.

(51) Int. Cl. A61H 1/00; A61H 23/02

(52) U.S. Cl. 601/46; 601/73; 601/80

(57) ABSTRACT

A hand-held massage assembly includes a power cord connectable to an electrical power supply, a vibratory massager, and a handle conductively coupling the power cord and massager. The handle may be removed and the power cord coupled directly to the massager. The vibratory massager includes a relatively flat working surface and a second connector for receiving either the first connector of the power cord or a first end of a handle.

### RELATED APPLICATION

This application claims the benefit of U.S. Provisional Application No. 60/478,717, filed on Jun. 16, 2003.

### BACKGROUND OF THE INVENTION

The present invention generally relates to a massage device. More particularly, the present invention relates to a hand-held massage device with a removable handle.

Massaging devices for stimulating the skin, muscles and blood circulation are well known. In general, hand-held massage devices are difficult to use on oneself and require the use of a second party in order for a user to avoid having to twist and contort their body in order to reach relatively inaccessible portions of a user's back. Handles on conventional devices have been used to reduce the amount of twisting and contortion necessary for a user to reach those hard-to-get spots, but the handle of the massage device can be obtrusive and make it difficult for a user to manipulate the massage device when the user desires to reach a relatively easy-to-reach spot, such as the user's shoulders. Therefore existing hand-held massagers can be much less effective if they require the presence of a second party to reach the hard-to-get spots on the user's back and if the handle of the device makes it difficult for the user, on their own, to manipulate the device so the user can massage a portion of their body such as their shoulders.

A number of devices have been created for the purpose of providing a massage. For example, U.S. Pat. No. 4,757,806, discloses a portable massage unit. However, the massage unit is bulky and its reach limited as the massage applicator is connected to a relatively large power unit by a relatively short cord. In another example, U.S. Pat. No. 4,846,158, discloses a hand-held massage device. However, the hand-held device requires the use of a fixed handle and a power cord which is permanently attached to the massage device.

Accordingly, there is a need for a hand-held massage device that is modular. There is also a need for a hand-held massage device that allows a user the ability to reach hard-to-get spots while allowing the user to also more easily manipulate the device when massaging their shoulders or arms. There is a further need for a hand-held massage device which allows a user the option of using the device with or without a handle. The present invention satisfies these needs and provides other related advantages.

### SUMMARY OF THE INVENTION

The present invention provides a hand-held massage assembly that is modular and allows a user the ability to reach hard-to-get spots while allowing the user to also more easily manipulate the assembly when massaging easily reachable spots such as their shoulders or arms. The massage assembly allows a user the option of using a massager of the assembly with or without a handle. The massage assembly is designed and manufactured in a way that will provide for easy detachment of the handle. The handle is intended to facilitate self massage whereas, in the event the massage is implemented by a second party, the handle may prove to be an extraneous appendage not necessary for manipulation and massage.

In accordance with an embodiment of the present invention, the hand-held massage assembly includes a power cord connectable to an electrical power supply. The power cord includes a first connector for providing electrical and mechanical connection of the power cord to the rest of the assembly. The assembly also includes a vibratory massager and a handle conductively coupling the power cord and massager. The handle may be removed and the power cord coupled directly to the massager via the first connector.

The vibratory massager includes a relatively flat working surface and a second connector for receiving either the first connector of the power cord or a first end of the handle. The second connector extends approximately 90 degrees from the working surface of the vibratory massager and allows the user to manipulate the assembly to reach various parts of the user's body.

The handle is tubular in shape and includes a first end attachable to the vibratory massager, and a second end attachable to the power cord. The first end of the handle comprises a first connector similar to the first connector of the power cord, and the vibratory massager includes a second connector for receiving either the first connector of the handle or the first connector of the power cord. The second end of the handle comprises a second connector similar to the second connector of the vibratory massager, for receiving the first connector of the power cord.

The first connector of the power cord comprises a threaded male connector and the second connector of the vibratory massager comprises a threaded female connector for mating engagement with the male connector of the power cord. The first connector of the handle comprises a threaded male connector for engaging the threaded female connector of the massager, and the second connector of the handle comprises a threaded female connector for engaging the threaded male connector of the power cord. The first connector of the power cord is attachable to one of the threaded female connector of the massager or the threaded female connector of the handle.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an orthogonal view of a hand held massage device including a massage unit, handle, and power plug embodying the present invention;

FIG. 2 is an orthogonal exploded view of the massage device of FIG. 1;

FIG. 3 is an exploded orthogonal view of the hand held massage device of FIG. 1 without the handle and the power plug connected directly to the massage unit; and

FIG. 4 is an orthogonal view of the hand held massage device of FIG. 3.

### DETAILED DESCRIPTION OF THE PREFERRED EMBODIMENT

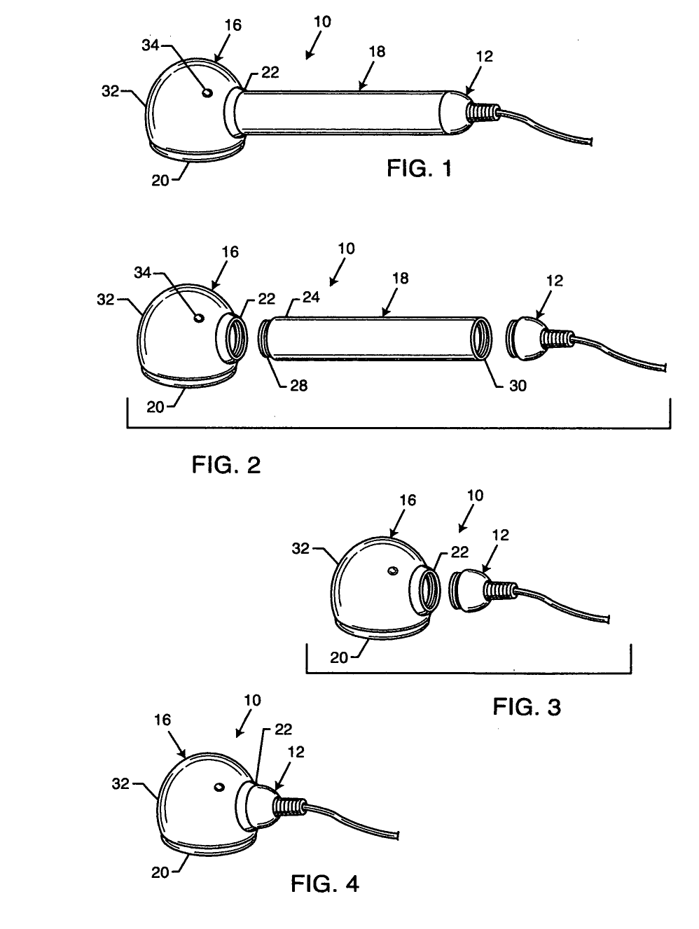

As shown in the drawings for purposes of illustration, an embodiment of the present invention resides in a hand-held massage assembly 10. As illustrated in FIGS. 1-4, the hand-held massage assembly 10 includes a power cord 12 connectable to an electrical power supply (not shown), such as an electrical wall socket. The power cord 12 includes a connector 14 for mechanically and electrically connecting to the remainder of the assembly 10. The assembly 10 also includes a vibratory massager 16 and a handle 18 conductively coupling the power cord 12 and massager16.

The massaging assembly 10 may be implemented either with or without the handle 18. The handle 18 is removable and the power cord 12 can be coupled directly to the massager 16. The detachable handle 18 may either include electronic wiring (not shown) or, in the alternative, be devoid of wiring. The power cord 12 (i.e., the electrical connection that drives the massager 16) may either be hooked to or through the handle 18 or it may be directly hooked to the massager 16. Portions of the power cord 12, massager 16 and handle 18 are made from plastic while other portions are made from a suitable metal.

The vibratory massager 16 includes a relatively flat working surface 20 and a connector 22 for receiving either the connector 14 of the power cord 12 or a first end 24 of the handle 18. The connector 22 of the massager 16 extends approximately 90 degrees from the working surface 20 of the vibratory massager 16.

The handle 18 is tubular in shape and includes the first end 24 attachable to the vibratory massager 16, and a second end 26 attachable to the power cord 12. The first end 24 of the handle 18 comprises a first connector 28 similar to the connector 14 of the power cord 12. The connector 22 of the vibratory massager 16 receives either the first connector 28 of the handle 18 or the connector 14 of the power cord 12. The second end 26 of the handle 18 comprises a second connector 30 similar to the connector 22 of the vibratory massager 16, for receiving the connector 14 of the power cord 12.

The connector 14 of the power cord 12 comprises a threaded male connector and the connector 22 of the vibratory massager 16 comprises a threaded female connector. The first connector 28 of the handle 18 comprises a threaded male connector for engaging the threaded female connector 22 of the massager 16. The second connector 30 of the handle 18 comprises a threaded female connector for engaging the threaded male connector 14 of the power cord 12. The connector 14 of the power cord 12 is attachable to one of the threaded female connectors 22, 30 of, respectively, the massager 16 or the handle 18.

While the power cord 12, massager 16, and handle 18 are discussed above in the context of threadedly engaging each other but the power cord 12, massager 16, and handle 18 may also be removably attachable to each other using various other methods including, but not limited to slide lock connections, slot and bayonet connections or the like.

The massager 16 includes a housing 32 that is generally spherical except for the relatively flat working surface 20. A power switch 34 electrically connected to the power source is located on the housing 32 and is also electrically connected to a motor (not shown) within the housing 32. Alternatively, a power switch may also be located on the handle 18 so that power switches are located at the two locations in order to accommodate various different hand positions that may be used during use of the massage assembly 10. For example, a user may hold the assembly 10 in one position when trying to reach their lower back and in another position when trying to reach their upper back. In this manner an on/off switch 34 is located convenient to a user's fingers whether or not the handle 18 is being used. In another alternative, the connector 22 may be movable between a position on the housing 32 that is 90 degrees from the working surface 20 to a position on the housing 32 that is 270 degrees or more from the working surface 20.

Alternatively, the handle 18 could function as a power unit for the massager 16 and eliminate the need for the power cord 12. The handle 18 could include an elongated, generally cylindrical housing similar to the tubular shape mentioned above. The first end 24 of the handle 18 would engage the massager 16 as discussed above. The power supply could be in the form of batteries (rechargeable or non-rechargeable) that would be located within the handle 18.

In another alternative, the power cord 12 could be replaced by a relatively small power pack (not shown) that could be mechanically/electrically connected to either the massager 16 or the handle 18.

Although an embodiment has been described in detail for purposes of illustration, various modifications may be made without departing from the scope and spirit of the invention.

What is claimed is:

1. A hand-held massage assembly, comprising:
a power cord connectable to an electrical power supply, including a first connector;
a vibratory massager; and
a handle conductively coupling the power cord and massager;
wherein the handle may be removed and the power cord coupled directly to the massager.

2. The assembly of claim 1, wherein the vibratory massager includes a relatively flat working surface and a second connector for receiving either the first connector of the power cord or a first end of the handle.

3. The assembly of claim 2, wherein the second connector extends approximately 90 degrees from the working surface of the vibratory massager.

4. The assembly of claim 1, wherein the handle includes a first end attachable to the vibratory massager, and a second end attachable to the power cord.

5. The assembly of claim 4, wherein the first end of the handle comprises a first connector similar to the first connector of the power cord, and the vibratory massager includes a second connector for receiving either the first connector of the handle or the first connector of the power cord.

6. The assembly of claim 5, wherein the second end of the handle comprises a second connector similar to the second connector of the vibratory massager, for receiving the first connector of the power cord.

7. The assembly of claim 6, wherein the first connector of the power cord comprises a threaded male connector, the second connector of the vibratory massager comprises a threaded female connector, the first connector of the handle comprises a threaded male connector for engaging the threaded female connector of the massager, and the second connector of the handle comprises a threaded female connector for engaging the threaded male connector of the power cord.

8. The assembly of claim 1, wherein the handle is tubular.

9. The assembly of claim 1, wherein the first connector is a threaded male connector attachable to one of a threaded female connector of the massager or a threaded female connector of the handle.

10. A hand-held massage assembly, comprising:
a power cord connectable to an electrical power supply, including a first connector;
a vibratory massager including a relatively flat working surface and a second connector; and
a handle including a first end attachable to the vibratory massager, and a second end attachable to the power cord, the handle conductively coupling the power cord and massager;
wherein the second connector receives either the first connector of the power cord or a first end of the handle, and the handle may be removed and the power cord coupled directly to the massager.

11. The assembly of claim 10, wherein the second connector extends approximately 90 degrees from the working surface of the vibratory massager.

12. The assembly of claim 10, wherein the first end of the handle comprises a first connector similar to the first connector of the power cord, and the vibratory massager includes a second connector for receiving either the first connector of the handle or the first connector of the power cord.

13. The assembly of claim 12, wherein the second end of the handle comprises a second connector similar to the second connector of the vibratory massager, for receiving the first connector of the power cord.

14. The assembly of claim 13, wherein the first connector of the power cord comprises a threaded male connector, the second connector of the vibratory massager comprises a threaded female connector, the first connector of the handle comprises a threaded male connector for engaging the threaded female connector of the massager, and the second connector of the handle comprises a threaded female connector for engaging the threaded male connector of the power cord.

15. The assembly of claim 10, wherein the handle is tubular.

16. The assembly of claim 10, wherein the first connector is a threaded male connector attachable to one of a threaded female connector of the massager or a threaded female connector of the handle.

17. A hand-held massage assembly, comprising:
a power cord connectable to an electrical power supply, including a first connector;
a vibratory massager including a relatively flat working surface and a second connector extending approximately 90 degrees from the working surface; and
a handle including a first end attachable to the vibratory massager, and a second end attachable to the power cord, the handle conductively coupling the power cord and massager;
wherein the second connector receives either the first connector of the power cord or a first end of the handle, and the handle may be removed and the power cord coupled directly to the massager.

18. The assembly of claim 17, wherein the first end of the handle comprises a first connector similar to the first connector of the power cord, and the vibratory massager includes a second connector for receiving either the first connector of the handle or the first connector of the power cord.

19. The assembly of claim 18, wherein the second end of the handle comprises a second connector similar to the second connector of the vibratory massager, for receiving the first connector of the power cord.

20. The assembly of claim 19, wherein the first connector of the power cord comprises a threaded male connector, the second connector of the vibratory massager comprises a threaded female connector, the first connector of the handle comprises a threaded male connector for engaging the threaded female connector of the massager, and the second connector of the handle comprises a threaded female connector for engaging the threaded male connector of the power cord.
